(19) United States
(12) Patent Application Publication
(10) Pub. No.: US 2009/0152951 A1
(43) Pub. Date: Jun. 18, 2009

(54) Electric system for providing uninterruptible power

(75) Inventor: Marcelo Claudio Algrain, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/000,842

(22) Filed: Dec. 18, 2007

(51) Int. Cl. H02J 9/00; H02J 7/00; F02D 29/06

(52) U.S. Cl. 307/65; 290/50; 307/66; 290/40 B

(57) ABSTRACT

A power supply system is disclosed. The system may include at least one engine configured to provide a mechanical power output. The system may further include at least one generator operatively coupled to the at least one engine and configured to convert at least a portion of the mechanical power output into an AC electrical power output at a first frequency. The system may further include an uninterruptible power supply electrically coupled to the at least one generator, the uninterruptible power supply having at least one energy storage device configured to store an electrical power. The uninterruptible power supply may further include a power conversion device electrically coupled to the at least one energy storage device and the at least one generator and configured to convert the AC electrical power output at the first frequency and the electrical power stored in the at least one energy storage device to an AC electrical power at a second frequency.

### TECHNICAL FIELD

The present disclosure relates generally to an electric system, and more particularly, to an electric system that provides uninterruptible power to a load.

### BACKGROUND

Engine-driven generator sets, commonly referred to as gensets, are often used to provide backup power to a load when a primary power source is disabled or offline. Typically, these gensets include a diesel or gasoline powered combustion engine configured to generate a mechanical power output. Gensets may also include an electric generator, coupled to the combustion engine and configured to convert at least a portion of the mechanical energy to electric energy. The electric energy may be used to operate electrical devices and/or stored for future use.

Gensets may be used in conjunction with an uninterruptible power supply (UPS). In most cases, the UPS stores energy by drawing power from the primary power source while the primary power source is enabled and online. In this manner, the UPS functions as an energy storage device. Should the primary power source become disabled or disconnected, the UPS may provide immediate backup power to the load until the genset is started, at which time the UPS may transfer the load feeding responsibilities to the genset.

Although combined genset and UPS (genset/UPS) systems may provide reliable solutions to power failures, conventional gensets are configured to operate at a fixed frequency corresponding with the frequency required by the loads. Matching generator frequency with the frequency of a load may require the use of a synchronous generator, thereby limiting genset design choices to fixed frequency generators that are appropriately sized to meet the power requirements of the load. Such generators are often large and inefficient and, as a result, tend to emit large amounts of emissions, as well as make it difficult for remote placement.

One method of reducing the size, noise, and emissions of combined genset/UPS systems is set forth in U.S. Pat. No. 5,880,537 (the '537 patent) issued to A. Windhorn on Mar. 9, 1999. The '537 patent discloses a UPS configuration that is comprised of a battery, as well as a main electric motor connected in series with an induction motor and a generator, via a shaft. The main electric motor, powered by a feed from an electric utility, is used to provide mechanical power to the generator through the shaft. The generator converts the mechanical power into electrical power, and then uses the electrical power to feed the load. If the utility fails, the induction motor will use the stored electrical energy from the battery to continue the rotation of the shaft, thereby continuing the supply of mechanical power to the generator. Because the UPS configuration of the '537 patent employs electric motors to provide the mechanical power necessary to drive the generator, the noise, size, and emission levels may be reduced when compared with conventional gensets that employ large, noisy combustion engines.

It may be desirable for a UPS system to have improved features. For example, a way of charging the battery in the UPS may be desirable.

The presently disclosed electrical system for providing uninterruptible power is directed toward improving systems of the past.

### SUMMARY

An aspect of the present disclosure is directed to a power supply system. The system may include at least one engine configured to provide a mechanical power output. The system may further include at least one generator operatively coupled to the at least one engine and configured to convert at least a portion of the mechanical power output into an AC electrical power output at a first frequency. The system may further include an uninterruptible power supply electrically coupled to the at least one generator, the uninterruptible power supply having at least one energy storage device configured to store an electrical power. The uninterruptible power supply may further include a power conversion device electrically coupled to the at least one energy storage device and the at least one generator and configured to convert the AC electrical power output at the first frequency and the electrical power stored in the at least one energy storage device to an AC electrical power at a second frequency.

Another aspect of the present disclosure is directed to a method for providing uninterruptible power to a system load. The method may include monitoring a power level associated with at least one primary power source. The method may further include determining a power requirement associated with a system load. The system may further include converting electrical energy stored in an energy storage device to an AC electrical power at a first frequency associated with the system load, if the monitored power level is less than the power requirement. The method may further include activating a variable-frequency generator if the electrical energy stored in the energy storage device falls below a threshold level, the genset configured to generate AC electrical power at a second frequency. The method may further include converting the AC electrical power at the second frequency to AC electrical power at the first frequency.

### BRIEF DESCRIPTION OF THE DRAWINGS

FIG. 1 is a block illustration of an exemplary disclosed combined genset/UPS system; and

FIG. 2 is a flowchart illustrating an exemplary disclosed method for operating the combined genset/UPS system of FIG. 1.

### DETAILED DESCRIPTION

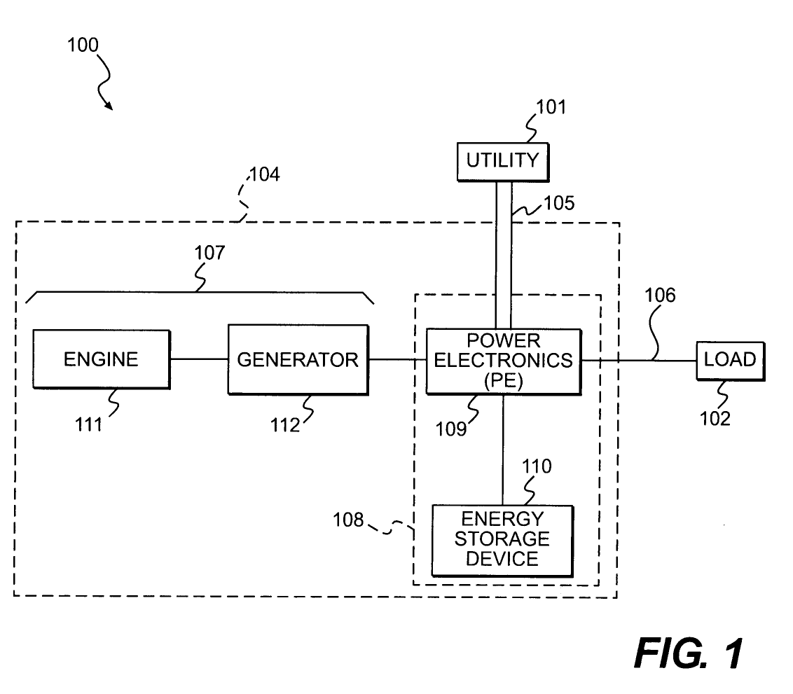

FIG. 1 illustrates an exemplary genset/UPS system 100 consistent with certain disclosed embodiments. System 100 may be configured to provide backup power and quality power correction to a system load. In one exemplary embodiment, backup power may include system 100 supplying immediate reserve power to a load when a power grid utility fails. In another exemplary embodiment, quality power correction may include system 100 correcting the power received from a power grid utility to ensure that the power from the power grid utility is balanced, three phase, and sinusoidal.

As shown in FIG. 1, system 100 may include power grid utility 101, system load 102, and genset/UPS 104. Utility 101 may be electrically coupled to genset/UPS 104 via power transmission network 105. Genset/UPS 104 may be electrically coupled to one or more loads 102 via an electrical connection 106.

Utility 101 may be an electricity generation and/or distribution system that generates and delivers electrical power through a centralized power grid and may be configured as the primary source of power associated with system 100. For example, utility 101 may include any type of system that generates and/or supplies electrical power including, for example, nuclear-generated electrical power plants, wind-powered generators, solar-powered generators, hydroelectric power plants, gaseous-generated electrical power systems, etc. In one exemplary embodiment, utility 101 may be a fee-based electricity generation and/or distribution system that provides electrical power to one or more customers. In another exemplary embodiment, utility 101 may be a mobile self-supporting electricity generation and/or distribution system such as, for example, a machine (e.g., construction equipment and/or agricultural equipment) or motorized vehicle (e.g., a bus or a truck). One skilled in the art will appreciate that utility 101 may produce electrical power in multiple phases and/or different frequencies based upon the requirements of the load. In one exemplary example, utility 101 may produce and/or supply electrical power in the form of an alternating electric current such as, for example, three-phase alternating current with a preset frequency (e.g., 50 Hz, 60 Hz, or any other suitable frequency).

Load 102 may include any type of power consuming systems or device(s) configured to receive electrical power supplied by utility 101 and/or utilize the electrical power to perform some type of task. Load 102 may include, for example, electrical equipment, lights, motors, heating elements, electronic circuitry, refrigeration devices, air conditioning units, computer servers, etc. In one exemplary embodiment, load 102 may include one or more systems and/or devices that utilize uninterrupted electrical power to perform one or more critical, sensitive, and/or important tasks. For example, loads 102 that may utilize uninterrupted power may include those found in hospitals, airports, computer servers, telecommunication installations, and/or industrial applications.

Network 105 may embody any electrical transmission and/or distribution system for distributing electrical power (i.e., electrical current and/or voltage) generated by utility 101. For example, network 105 may include an electrical power distribution system comprised of power stations, transmission circuitry, power lines, substations, electrical equipment (e.g., transformers, electrical switches, power relays, circuit breakers, and the like), and other suitable equipment for distributing electrical power across a power grid. In one embodiment, portions of network 105 may be buried underground, run overhead via transmission towers and/or tension towers, or interconnected with electrical systems by any other suitable means.

Connection 106 may include any type of electrical connector or electrical connection system that is capable of electrically coupling one or more of genset/UPS 104, utility 101, and/or load 102. For example, connection 106 may be constructed of any type of electrically conductive material (e.g., copper, aluminum, steel, metal alloy, etc.). Connection 106 may also include various electrical connections or connectors, junction boxes, circuit interrupting devices, fuses, or any other components that may be suitable for electrically interconnecting one or more electrical systems. Connection 106 may also include a voltage transformer configured to reduce the voltage provided by genset/UPS 104, and/or utility 101, to a suitable voltage level for use by conventional consumer devices.

Genset/UPS 104 may include a plurality of components and subsystems for generating and maintaining an uninterruptible source of power for system 100. For example, genset/UPS 104 may include a genset 107 configured to generate an electrical power output and a UPS 108 configured to provide an immediate power supply in the event of a power fault associated with utility 101. UPS 108 may be configured to operate until genset 107 comes online. Genset 107 may further include an automated supervisory control system that may continuously monitor functionality of utility 101 and/or genset/UPS 104 and initiate appropriate corrective action in the event of a power interruption. For example, the automated supervisory control system may monitor the functionality of utility 101 through voltage sensors, current sensors, etc. If the automated supervisory control system detects that utility 101 is unable to supply adequate power to load 101, the automated supervisory control system may be used to transfer the load bearing responsibilities of load 101 from utility 102 to genset/UPS 104.

Genset 107 may include any component or components that operate to generate electricity. In one embodiment, genset 107 may comprise an engine 111 connected in series with a generator 112. Genset 107 may also include various types of information-processing components such as, for example, hardwired control circuits (not shown), microprocessors (not shown), and/or computer-readable storage devices (e.g., random access memory, flash memory, etc. (not shown)). Additionally or alternatively, genset 107 may include an operator interface (not shown) through which an operator may monitor and/or control one or more aspects of the operation of genset/UPS 104.

Engine 111 may be at least one power-producing device that is configured to output mechanical energy. In one exemplary embodiment, engine 111 may be an internal combustion engine having multiple subsystems that cooperate to produce a mechanical power output. One skilled in the art will recognize that engine 111 may be any type of internal combustion engine such as, for example, a gasoline or diesel-powered engine. The subsystems included within engine 111 may include, for example, a fuel system, an air induction system, an exhaust system, a lubrication system, a cooling system, and/or any other appropriate system(s).

Generator 112 may be any type of device configured to receive mechanical power from engine 111, and then convert at least a portion of the mechanical power into electrical energy. For example, generator 112 may be a variable-frequency alternating current generator, a fixed-frequency alternating current generator, an induction generator, a permanent-magnet generator, a switched-reluctance generator, or any other generator. In one embodiment, generator 112 may be configured to generate three-phase alternating current.

UPS 108 may comprise a power electronics (PE) 109 and an energy storage device 110. Energy storage device 110 may include any device that can use electrical power to store energy such as, for example, a battery, a flywheel, an inductor, and/or a capacitor. The power supplied from utility 101 to energy storage device 110 may be used to charge or maintain the charge in energy storage device 110.

Power Electronics (PE) 109 may embody an electronic device that is configured to convert, condition, and/or regulate the production, absorption, and/or flow of electrical power in system 100. In one embodiment, PE 109 may be configured to regulate the production and/or flow of electrical power by receiving an input of fixed or variable-frequency alternating current (AC) and/or direct current (DC). PE 109 may be further configured to output a variable or fixed-frequency AC (e.g., 60 Hz or 50 Hz), and/or DC, based on the received input. For example, when utility 101 is capable of sustaining load 102, PE 109 may convert residual AC power from utility 101 to AC or DC power, and then forward the AC or DC power to energy storage device 110 in order to maintain the charge of energy storage device 110. Alternatively, when utility 101 is not capable of sustaining load 102, either in part or in total, PE 109 may draw power from energy storage 110 and convert it (e.g., from DC power to AC power, or AC power to fixed AC power) to properly sustain load 102. For example, if energy storage device 110 is a DC power energy storage device (e.g., a battery), PE 109 may draw DC power from energy storage device 110, convert the DC power to a fixed-frequency AC power, and then forward the fixed-frequency AC power to load 102. Additionally, when the energy in energy storage device 110 drops below a preset threshold, PE 109 may convert power from genset 107 to sustain load 102 and/or recharge energy storage 110. Additionally, PE 109 may configured to parallel multiple power producing devices (i.e., synchronizing their frequencies, aligning phase angles, matching voltages, regulating currents, etc.) and control the direction of flow of the power signals. In one exemplary embodiment, PE 109 may include reactors, capacitors, power semiconductor devices such as, semiconductor switching devices (e.g., diodes, thyristors, insulated gate bipolar transistors, silicon controlled rectifiers, and the like), and control electronics (e.g., hardwired circuits, logic circuits, microprocessors, gate drivers, sensors, etc.) in order to perform its required operation.

According to one embodiment, genset/UPS 104 may be configured to monitor voltage, current, and/or frequency characteristics of utility 101. For example, genset/UPS 104 may actively monitor the characteristics associated with utility 101 through a control monitoring system (not shown). The control monitoring system may periodically or continuously measure utility 101 characteristics using current sensors, voltage sensors, frequency sensors, etc. In another example, genset/UPS 104 may passively monitor utility 101 through electrical components (e.g., relays). For example, relays, used to form logic circuits, may be located within genset/UPS 104. The logic circuits may appropriately switch when the voltage from utility 101 drops below a certain threshold.

One skilled in the art will recognize that alternate configurations of system are possible. For example, in one embodiment, utility 101 may be electrically coupled upstream, or downstream, of PE 109 through suitable coupling means.

### INDUSTRIAL APPLICABILITY

The disclosed method and system may provide an electric power generation system for providing uninterruptible power to a load. In particular, the disclosed method and system may be used to implement a combined genset/UPS system, wherein a power electronic component converts and conditions a flow of power signals in system 100. By providing power electronics for converting almost any generator output frequency to a desired load frequency, users are not limited to selecting genset systems that provide a particular output frequency. Users may, therefore, have the flexibility to select genset systems based on other criteria such as, cost, efficiency, size, etc., regardless of the frequency of the output power. For example, having the capability of generating power asynchronously to the load requirements enables the use of higher speed and higher output engines which may further improve the overall power density of the genset.

Another benefit of an integrated genset/UPS system may be the capability of combining genset/UPS system power to increase generating capacity on a short-term basis. This may enable the selection of smaller more efficient engines. Still further, the integrated genset/UPS 104 may be used to fully or partially fulfill load requirements to a system load during peak hours, thereby reducing large fluctuations on utility power requirements which may result in lowering utility charges.

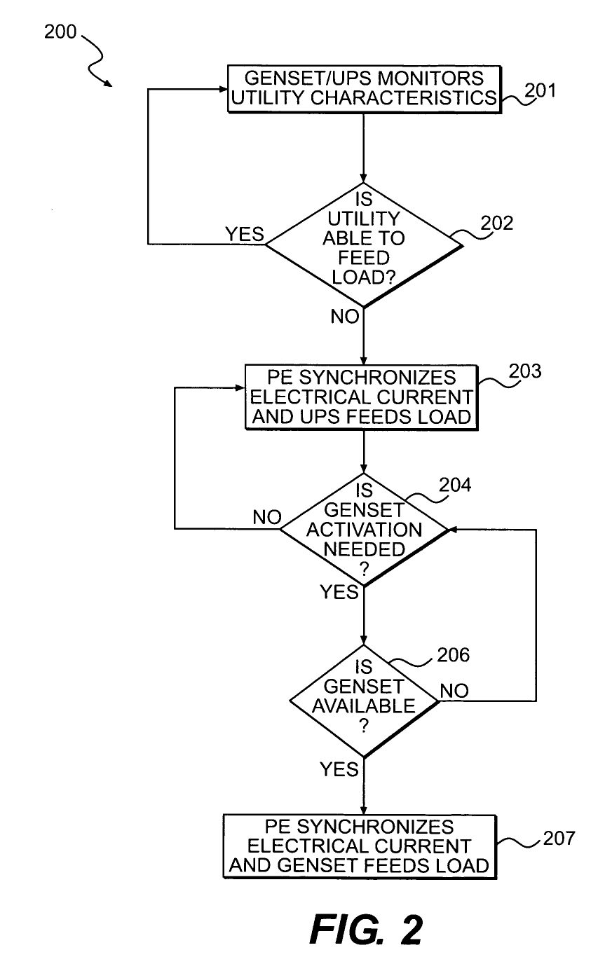

FIG. 2 illustrates a flowchart 200 depicting a method for operating system 100 to provide uninterruptible power to load 102. FIG. 2 will be now be discussed in further detail to illustrate the disclosed system and its operation.

As illustrated in flowchart 200, genset/UPS 104 may monitor characteristics associated with utility 101. For example, genset/UPS 104 may use current sensors, voltage sensors, frequency sensors, etc. to passively and/or actively monitor voltage, current, and/or frequency characteristics associated with utility 101 (step 201). Genset/UPS 104 may use the characteristics to determine whether the power level provided by utility 101 is sufficient to meet the power requirements of load 102 (step 202). The monitored characteristics of utility 101 may be stored in a computer-readable memory device in genset/UPS 104. Consequently, an automated supervisory control system may continuously monitor functionality of utility 101 and/or genset/UPS 104 and initiate appropriate corrective action in the event of a power interruption. Alternatively, an operator may examine the stored characteristics to monitor the functionality of utility 101 and/or genset/UPS 104.

If utility 101 is able to feed load 102 with sufficient electrical power, genset/UPS 104 may continue the monitoring of utility 101 (step 202: Yes). Furthermore, while utility 101 is supplying electrical power to load 102, utility 101 may also charge (or maintain the charge of) energy storage device 110. For example, in one embodiment, utility 101 may supply PE 109 with fixed-frequency AC electrical power. PE 109 may use the internal components described previously to convert the fixed-frequency AC electrical power to DC electrical power. PE 109 may then deliver the DC electrical power to energy storage device 110 to charge energy storage device 110.

If utility 101 is unable to supply load 102 with the appropriate electrical power (step 202: No), UPS 108 may be operated to meet the electrical power requirements of load 102 (step 203). As an example, utility 101 may be unable to fully supply load 102 with electrical power due, for example, to an abnormality or defect in utility 101 and/or network 105. Thus, utility 101 may only be able to supply load 102 with 80% of the electrical power that load 102 may require. In this example, UPS 108 may supply load 102 with the remaining 20% of the electrical power required by load 102. In another exemplary embodiment, UPS 108 may fully assume the load bearing responsibilities of utility 101. For example, an electrical power failure may prevent utility 101 from providing electrical power to load 102. In this example, UPS 108 may be operated to meet the electrical power requirement of load 102.

As explained, UPS 108 may include energy storage device 110 that is adapted to store and distribute electrical power in the event that electrical power generated by a utility becomes unavailable. For example, energy storage device 110 may supply AC or DC electrical power to PE 109. In one embodiment, energy storage device 110 may be a flywheel driven generator that supplies variable-frequency AC electrical power to PE 109. In this embodiment, PE 109 may convert the variable-frequency AC electrical power into an appropriate fixed-frequency AC electrical power such as, for example, 60 Hz, 50 Hz, or any other frequency that may be used by load 102 (step 203). The fixed-frequency AC electrical power may then be delivered to load 102 via connection 106 (step 203). In another embodiment, energy storage device 110 may be a battery, and may supply DC electrical power to PE 109. In this embodiment, PE 109 may convert the DC electrical power into a fixed-frequency AC electrical power such as, for example, 60 Hz, 50 Hz, or any other frequency that may be used by load 102 (step 203). The fixed-frequency AC electrical power may then be delivered by PE 109 to load 102 via connection 106 (step 203).

In certain situations, it may become necessary to activate genset 107 before genset 107 can effectively provide electrical power to load 102 (step 204: Yes). For example, it may take genset 107 several seconds to reach steady-state operation. Accordingly, in order to ensure that continuous uninterrupted electrical power is provided to load 102, genset 107 may require starting some time before it can effectively provide electrical power to load 102. The activation of genset 107 may be based on several factors such as, for example, the energy remaining in energy storage device 110, the characteristics of load 102, and/or the ramp-up time of genset 107. A control system and/or an operator may take these factors into account and determine when genset 107 is to be activated. In one embodiment, the control system may be programmed for genset 107 to wait a predetermined amount of time from when utility 101 becomes unavailable before starting genset 107. In yet another embodiment, the control system may be programmed for genset 107 to be activated when the remaining electrical charge in energy storage device 110 drops below a predetermined threshold. In still another embodiment, the control system may be programmed for genset 107 to be activated immediately after utility 101 starts to function improperly. Furthermore, in one exemplary example, if genset 107 is not required to be activated (step 204: No), UPS 108 may continue to supply electrical power to load 102 until either genset 107 is used to feed load 102 (step 207) or utility 101 is working properly.

Before the activated genset 107 can feed load 102 (step 207), genset 107 must first be available to supply load 102 with electrical power (step 206: Yes). In one embodiment, genset 107 may be required to meet certain operating characteristics before genset 107 can feed load 102. For example, genset 107 may need to operate a certain amount of time to reach 90 percent of nominal voltage and/or frequency before being enabled to accept the load feeding responsibilities of load 102.

Once genset 107 is available (step 206: Yes), genset 107 may assume the load feeding responsibilities of utility 101 from UPS 108 (step 207). Genset 107 may feed load 102 by supplying variable-frequency AC electrical power to PE 109. PE 109 may convert the variable-frequency AC electrical power into a fixed-frequency AC electrical power such as, for example, 60 Hz, 50 Hz, or any other frequency that may be used by load 102 (step 207). PE 109 may then supply load 102 with the fixed-frequency AC electrical power via connection 106. Once utility 101 is functioning properly, the load bearing responsibilities of load 102 may be transferred back to utility 101. While providing electrical power to load 102, genset 107.may also simultaneously charge energy storage device 110. In one embodiment, PE 109 may convert residual variable-frequency AC electrical power from genset 107 into DC electrical power, and then deliver the DC electrical power to energy storage device 110.

Traditional genset/UPS configurations do not include integrated solutions for matching generator frequency with load frequency and, therefore, require that the generator frequency be matched to the load, thus limiting the flexibility of generator options to synchronous gensets. In this disclosure, PE 109 is used as a means to integrate the two systems by being configured to convert, condition, and/or regulate the production, absorption, and/or flow of electrical power in system 100. The introduction of PE 109 may ensure that generator 112 will not be used to directly feed load 102, thereby allowing system designers flexibility in choosing gensets/UPS systems that are suitable for a particular task. For example, a system designer may choose a smaller/faster engine and/or a variable frequency generator for the task of feeding a relatively small load. The smaller/faster engine and/or the addition of a variable frequency generator may result in higher fuel efficiency, lower emission levels, and easier remote placement of genset 107.

It will be apparent to those skilled in the art that various modifications and variations can be made to the disclosed systems and methods for providing uninterruptible electrical power. Other embodiments of the method and system will be apparent to those skilled in the art from consideration of the specification and practice of the method and system disclosed herein. It is intended that the specification and examples be considered as exemplary only, with a true scope of the disclosure being indicated by the following claims and their equivalents.

What is claimed is:

1. A power supply system, comprising:
at least one engine configured to provide a mechanical power output;
at least one generator operatively coupled to the at least one engine and configured to convert at least a portion of the mechanical power output into an AC electrical power output at a first frequency;
an uninterruptible power supply electrically coupled to the at least one generator, the uninterruptible power supply comprising:
at least one energy storage device configured to store an electrical power; and
a power conversion device electrically coupled to the at least one energy storage device and the at least one generator and configured to convert the AC electrical power output at the first frequency and the electrical power stored in the at least one energy storage device to an AC electrical power at a second frequency.

2. The power supply system of claim 1, wherein the power conversion device is electrically coupled to a primary power source, the primary power source configured to provide a AC electrical power at a third frequency.

3. The power supply system of claim 2, wherein the at least one energy storage device includes at least one battery configured to store DC electrical power.

4. The power supply system of claim 2, wherein the at least one energy storage device is configured to store AC electrical power.

5. The power supply system of claim 3, wherein the power conversion device is further configured to:
receive, from the primary power source, the AC electrical power at the third frequency;
convert the AC electrical power at the third frequency to a DC electrical power; and
store the DC electrical power in the at least one battery.

6. The power supply system of claim 3, wherein the power conversion device is further configured to:
receive, from the at least one generator, the AC electrical power at the first frequency;
convert the AC electrical power at the first frequency to a DC electrical power; and
store the DC electrical power in the at least one battery.

7. The power supply system of claim 4, wherein the power conversion device is further configured to:
receive, from the primary power source, the AC electrical power at the third frequency;
convert the AC electrical power at the third frequency to AC electrical power at a fourth frequency; and
store the AC electrical power at the fourth frequency in the at least one energy storage device.

8. The power supply system of claim 4, wherein the power conversion device is further configured to:
receive, from the at least one generator, the AC electrical power at the first frequency;
convert the AC electrical power at the first frequency to AC electrical power at a fourth frequency; and
store the AC electrical power at the fourth frequency in the at least one energy storage device.

9. The power supply system of claim 1, wherein the at least one generator is a variable-frequency generator.

10. The power supply system of claim 1, wherein the second frequency is 60 Hz.

11. The power supply system of claim 1, wherein the second frequency is 50 Hz.

12. A method for providing uninterruptible power to a system load comprising:
monitoring a power level associated with a primary power source;
determining a power requirement associated with a system load;
converting electrical energy stored in an energy storage device to an AC electrical power at a first frequency associated with the system load, if the monitored power level is less than the power requirement;
activating a variable-frequency generator if the electrical energy stored in the energy storage device falls below a threshold level, the variable-frequency generator configured to generate AC electrical power at a second frequency; and
converting the AC electrical power at the second frequency to AC electrical power at the first frequency.

13. The method of claim 12, wherein the energy storage device includes a battery configured to store DC electrical power.

14. The method of claim 13, further including:
converting the AC electrical power at the second frequency to DC electrical power; and
storing the DC electrical power in the energy storage device.

15. The method of claim 13, further including:
receiving an AC electrical power at a fourth frequency associated with the primary power source;
converting the AC electrical power at the fourth frequency to a DC electrical power; and
storing the DC electrical power in the energy storage device.

16. The method of claim 12, where the energy storage device is configured to store AC electrical power at a third frequency.

17. The method of claim 16, further including:
converting the AC electrical power at the second frequency to AC electrical power at the third frequency; and
storing the AC electrical power at the third frequency in the energy storage device.

18. The method of claim 16, further including:
receiving an AC electrical power at a fourth frequency associated with the primary power source;
converting the AC electrical power at the fourth frequency to AC electrical power at a third frequency; and
storing the AC electrical power at the third frequency in the energy storage device.

19. A genset and an uninterruptible power supply configuration, comprised of:
at least one engine;
at least one generator;
at least one energy storage device;
at least one primary power source;
at least one load electrically coupled to the at least one generator, the at least one energy storage device, and at least one primary power source and configured to receive electrical power from the at least one generator, the at least one energy storage device, and at least one primary power source; and
a power electronics circuit configured to synchronize a frequency and control a direction of flow of electrical power between the at least one generator, the at least one energy storage device, and the at least one primary power source.

20. The configuration of claim 19, wherein the power electronics circuit is further configured to:
convert a variable-frequency AC electrical power to a fixed-frequency AC electrical power;
convert a DC electrical power to a fixed-frequency AC electrical power;
convert a fixed-frequency AC electrical power to a DC electrical power; and
convert a variable-frequency AC electrical power to a DC electrical power.

21. The configuration of claim 19, wherein the at least one generator is a variable-frequency generator.

22. An uninterruptible power supply electrically coupled to at least one generator, the uninterruptible power supply comprising:
at least one energy storage device configured to store an electrical power; and
a power conversion device electrically coupled to the at least one energy storage device and the at least one generator and configured to convert an AC electrical power output at a first frequency and an electrical power stored in the at least one energy storage device to an AC electrical power at a second frequency.
